(19) United States
(12) Patent Application Publication
(10) Pub. No.: US 2017/0230171 A1
(43) Pub. Date: Aug. 10, 2017

(54) SYSTEM AND METHOD OF MASKING AND COMPUTING ON MASKED DATA IN A DATA STORE

(71) Applicant: Massachusetts Institute of Technology, Cambridge, MA (US)

(72) Inventors: Vijay N. GADEPALLY, Watertown, MA (US); Jeremy V. KEPNER, Cambridge, MA (US); Peter W. MICHALEAS, Pelham, NH (US)

(21) Appl. No.: 15/239,856

(22) Filed: Aug. 18, 2016

Related U.S. Application Data
(60) Provisional application No. 62/209,446, filed on Aug. 25, 2015.

(51) Int. Cl. H04L 9/08; H04L 9/14; G06F 17/30

(52) U.S. Cl. CPC H04L 9/0822; G06F 17/30569; H04L 9/0861; H04L 9/0894; H04L 9/14

(57) ABSTRACT

Various embodiments are disclosed for efficiently masking a data set using sparse associative array representations, such that various computations may be performed directly on the masked data set in a data store with low computational overhead. Some embodiments may include transforming a data set into a sparse associative array representation (e.g., a sparse matrix table or graph) and masking the various components of the sparse associative array representation (e.g., row keys, column keys, values) to generate a masked associative array representation using different masking schemes. In some embodiments, results of the various computations performed on the masked data may be returned from the data store in masked form, so that only authorized users may unmask the computational results. Some embodiments may be particularly useful for outsourcing data storage and processing to untrusted server systems (e.g., cloud computing systems), while preserving the veracity of the underlying data.

### RELATED APPLICATIONS

This application claims the benefit of U.S. Provisional Patent Application No. 62/209,446, filed on Aug. 25, 2015, the entire contents of which are incorporated herein by reference.

### GOVERNMENT RIGHTS

This invention was made with government support under FA8721-05-C-0002 awarded by U.S. Air Force. The government has certain rights in the invention.

### BACKGROUND

Big data refers to large volumes of structured and/or unstructured data that may be analyzed computationally to reveal patterns, trends, and associations. Big data and big data systems for storing, analyzing, and retrieving data are commonly characterized by volume, velocity, and variety. Volume relates to the scale of data, velocity relates to the analysis of streaming data, and variety relates to the different forms of data. Increasingly, big data systems are further characterized by their ability to address challenges to the confidentiality, integrity and availability of data (referred to herein as “veracity”).

Examples of veracity challenges in a big data system may include external denial of service, credential stealing, cross virtual machine (VM) side channels, VM hypervisor privilege escalation, remote code injection, data integrity attacks, data loss, data exfiltration or data extrusion, insider threats, internal network resource attacks, and supply chain attacks, for example. Such attacks may threaten the availability, confidentiality, and integrity of data stored in the big data system as well as the results of any analytics performed on the data.

### SUMMARY

Various embodiments are disclosed for efficiently masking a data set using sparse associative array representations, such that various computations may be performed directly on the masked data set in a data store with low computational overhead. Some embodiments may include transforming a data set into a sparse associative array representation (e.g., a sparse matrix table or graph) and masking the various components of the sparse associative array representation (e.g., row keys, column keys, values) to generate a masked associative array representation using different masking schemes. In some embodiments, results of the various computations performed on the masked data may be returned from the data store in masked form, so that only authorized users may unmask the computational results. Some embodiments may be particularly useful for outsourcing data storage and processing to untrusted server systems (e.g., cloud computing systems), while preserving the veracity of the underlying data.

In some embodiments, masking a data set and performing computations on the masked data set may include a processor of a computing device transforming the data set into a sparse associative array representation having multiple dimensions and masking the sparse associative array representation to generate a masked associative array representation. The sparse associative array representation may include multiple keys in each dimensions and non-zero values that represent relationships between the keys in each dimension. The non-zero values and keys in each dimension may be masked using different masking schemes. The processor may store the masked associative array representation in a data store. In some embodiments, each of the sparse associative array representation and the masked associative array representation may be a sparse table matrix.

In some embodiments, the different masking schemes may include semantically secure encryption (RND), deterministic encryption (DET), order-preserving encryption (OPE), authenticated encryption (AUT), additively homomorphic encryption (HOM+), multi-party computation (MPC), or any combination thereof. In some embodiments, the keys in each dimension of the sparse associative array representation may include a key name and a value.

In some embodiments, masking a data set may further include the processor receiving a command to mask the data set, including the data set and an identifier for each of the different masking schemes to mask the non-zero values and the keys in each dimension of the sparse associative array representation.

In some embodiments, the keys of the sparse associative array representation may include column keys and row keys and the non-zero values may represent relationships between the column keys and the row keys. In some embodiments, masking the sparse associative array representation to generate the masked associative array representation may include the processor masking the non-zero values, the column keys and the row keys using different masking schemes.

In some embodiments, performing computations on the masked data set may include the processor receiving a command to perform an operation on the masked associative array representation including one or more operands, masking each of the one or more operands to generate one or more masked operands using one or more of the different masking schemes used to generate the masked associative array representation. The processor may transmit the command including the one or more masked operands, e.g., to a data store or remote computing device to perform the operation. In some embodiments, the operation to perform on the masked associative array representation may include one or more of a correlation, threshold, search query, addition, subtraction, multiplication, and Boolean operation.

In some embodiments, the processor may receive a masked output associative array representation in response to the operation being performed on the masked associative array representation and unmask the masked output associative array representation to generate an unmasked output associative array representation. The output associative array representation may be unmasked using the different masking schemes that were used to generate the masked associative array representation.

Further embodiments include a computing device including a processor configured with processor-executable instructions to perform operations of the embodiment methods summarized above. Further embodiments include a non-transitory processor-readable storage medium having stored thereon processor-executable instructions configured to cause a processor to perform operations of the embodiment methods summarized above. Further embodiments include a computing device including means for performing functions of the embodiment methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic diagram illustrating components of a computing device that may be configured to mask a data set based on a sparse associative array representation and perform computations on the masked data set according to some embodiments.

FIG. 2 is a process flow diagram illustrating a method of masking a data set based on a sparse associative array representation according to some embodiments.

FIG. 3 is a schematic diagram illustrating an example of masking a data set based on a sparse associative array representation according to the method of FIG. 2.

FIG. 4 is a process flow diagram illustrating a method of performing an operation on a masked associative array representation according to some embodiments.

FIG. 5 is a schematic diagram illustrating of an example of performing an operation on a masked associative array representation according to the embodiment method of FIG. 4.

FIGS. 6A through 6C are schematic diagrams illustrating of another example of performing an operation on a masked associative array representation according to the embodiment method of FIG. 4.

FIG. 7 is a schematic diagram illustrating components of a smartphone type mobile communication device suitable for use with various embodiments.

FIG. 8 is a schematic diagram illustrating components of a laptop computing device suitable for use with various embodiments.

FIG. 9 is a schematic diagram illustrating components of a server suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The term “computing device” is used herein to refer to an electronic device equipped with at least a processor. Examples of computing devices may include, but not limited to, mobile communication devices (e.g., cellular telephones, wearable devices, smart-phones, web-pads, tablet computers, Internet enabled cellular telephones, Wi-Fi® enabled electronic devices, personal data assistants (PDA's), etc.), personal computers (e.g., laptop computers, etc.), and servers. In various embodiments, computing devices may be configured with memory and/or storage as well as wired or wireless communication capabilities, such as network transceiver(s) and antenna(s) configured to establish a wide area network (WAN) connection (e.g., a cellular network connection, etc.) and/or a local area network (LAN) connection (e.g., a wireless connection to the Internet via a Wi-Fi® router, etc.).

The term “masking scheme” is use herein to refer to one or more of an encryption and digital authentication technique that may be applied to unencrypted data (e.g., plaintext) for the purpose of protecting the confidentiality, availability or integrity of the data.

The terms “data store” as used herein refers to a database, network-based storage, cloud storage, a storage cluster, or other storage device that may be accessible directly or indirectly, e.g., over a public or private communication network. In some embodiments, the data store may be capable of storing large volumes of data (e.g., big data). In some embodiments, the data store may support NoSQL for data storage and retrieval, such as an Apache Accumulo™ database or Paradigm4 SciDB™ database.

Cryptographic techniques exist for preserving the veracity of data in big data systems, including encryption of communication links between users and a big data system, encryption of communication links between data sources and the big data system, and encryption of data stored in the big data system. Although data may be stored in encrypted form, such techniques typically require the data to be decrypted before analytic computations may be performed on the data. Thus, encryption keys used to encrypt the data are generally accessible to the big data system, risking exposure of such keys and data to any hacker able to obtain access to the system. Some cryptographic techniques may allow analytic computations to be performed directly on encrypted data without first requiring the data to be decrypted. However, such cryptographic techniques are typically associated with significant computational overheads, making such techniques too slow for practical use in a big data system.

Various embodiments are disclosed for efficiently masking data using sparse associative array representations, such that various computations may be performed directly on the masked data in a data store with low computational overhead. For example, some embodiments may include transforming a data set into a sparse associative array representation (e.g., a sparse matrix table or graph) and masking the various components of the sparse associative array representation (e.g., row keys, column keys, values, etc.) to generate a masked associative array representation using different masking schemes. In some embodiments, results of the various computations performed on the masked data may be returned from the data store in masked form, so that only authorized users may unmask the computational results. Some embodiments may be particularly useful for outsourcing data storage and processing to untrusted server systems (e.g., cloud computing systems), while preserving the veracity of the underlying data.

By moving the semantic content of the data set to one or more components of the sparse associative array representation (e.g., row keys and/or column keys), different masking schemes may be used to provide different levels of data protection may be applied to each component. For example, in some embodiments, the different masking schemes used to mask each of the components of the sparse associative array representation may depend on the desired operations to be performed on the masked associative array representation and the computational overhead that may be tolerated by a particular application or service.

In some embodiments, the different masking schemes may include but are not limited to semantically secure encryption (RND), deterministic encryption (DET), order-preserving encryption (OPE), digital authentication (AUT), additively homomorphic encryption (HOM+), and multi-party computation (MPC). Each of these different masking schemes may provide different levels of protection, enabling different types of operations to be performed on masked data. The different levels of data protection and thus the functionality afforded by the different masking schemes may correspond to the amount of information that may be revealed or leaked from the masked data about the underlying data. Further, each of these different masking schemes may be associated with respective computational overheads that may affect the processing time for performing certain operations. Thus, by representing a data set using a sparse associative array representation and separately masking each component of the representation using a set of different masking schemes, tradeoffs may be made between performance of desired operations on the masked data set and computational overhead.

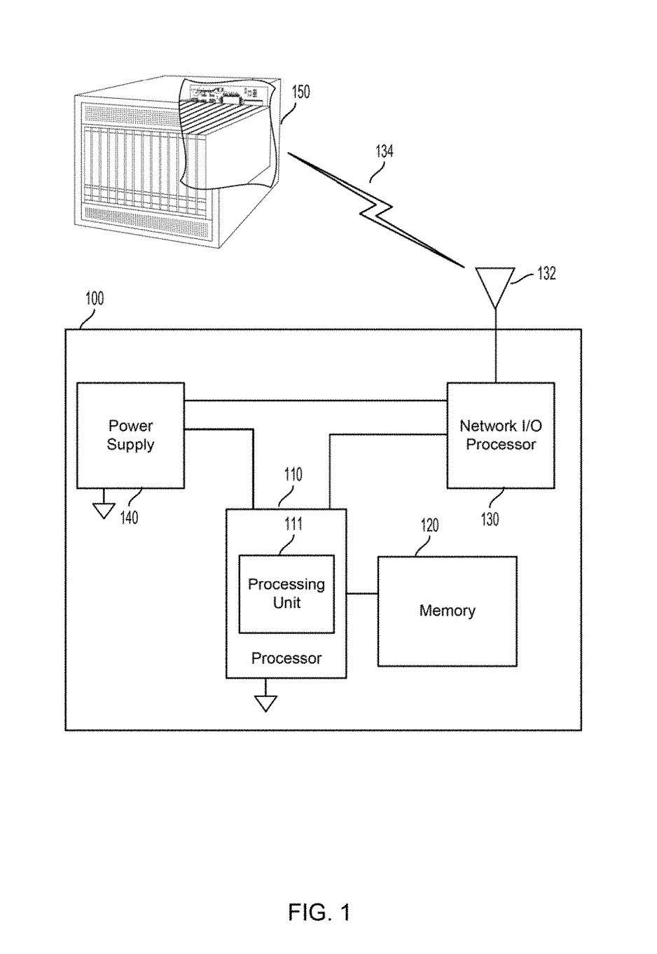

FIG. 1 is a schematic diagram illustrating components of a computing device that may be configured to mask a data set based on a sparse associative array representation and perform computations on the masked data set according to some embodiments. The computing device 100 may include various circuits and other electronic components used to power and control the operation of the device. The computing device 100 may include a processor 110, memory 120, a network input/output (I/O) processor 130, and a power supply 140.

In some embodiments, the processor 110 may be dedicated hardware specifically adapted to implement various operations of the computing device 100, including, but not limited to, mask a data set based on a sparse associative array representation and perform computations on the masked data set according to some embodiments. In some embodiments, the processor 110 may be or include a programmable processing unit 111 that may be programmed with processor-executable instructions to perform the various operations of the computing device 100. In some embodiments, the processor 110 may be a programmable microprocessor, microcomputer or multiple processor chip or chips that can be configured by software instructions to perform the various operations of the computing device 100. In some embodiments, the processor 110 may be a combination of dedicated hardware and a programmable processing unit 111.

In some embodiments, the memory 120 may store processor-executable instructions. In some embodiments, the memory 120 may be volatile memory, non-volatile memory (e.g., flash memory), or a combination thereof. In some embodiments, the memory 120 may include internal memory included in the processor 110, memory external to the processor 110, or a combination thereof.

In some embodiments, the processor 110 may be coupled to the network I/O processor 130 in order to communicate with a remote computing device 150 over a wired or wireless network connection 134. The network I/O processor 130 may be a two-way transceiver processor. The network I/O processor 130 may include a single transceiver chip or a combination of multiple transceiver chips for transmitting and receiving signals over the network connection 134. In some embodiments, the network I/O processor 130 may be a radio frequency (RF) processor configured to transmit and/or receive signals via an antenna 132 in one or more of a number of radio frequency bands depending on the supported type of communications.

The remote computing device 150 may be any of a variety of computing devices, including but not limited to a data store (e.g., a NoSQL database such as Apache Accumulo™ or Paradigm4 SciDB™), cellular telephones, smart-phones, web-pads, tablet computers, Internet enabled cellular telephones, wireless local area network (WLAN) enabled electronic devices, laptop computers, personal computers, and similar electronic devices equipped with at least a processor and a communication resource to communicate with the network I/O processor 130. Information may be transmitted from one or more components of the computing device 100 (e.g., the processor 110) to the remote computing device 150 over a wired or wireless network connection 134 using Bluetooth®, Wi-Fi®, TCP/IP, or other wired or wireless network communication protocol.

The processor 110, the memory 120, the network processor 130, and any other electronic components of the computing device 100 may be powered by the power supply 140. In some embodiments, the power supply 140 may be a battery, a solar cell, or other type of energy harvesting power supply. While the various components of the computing device 100 are illustrated in FIG. 1 as separate components, some or all of the components may be integrated together in a single device or module, such as a system-on-chip module.

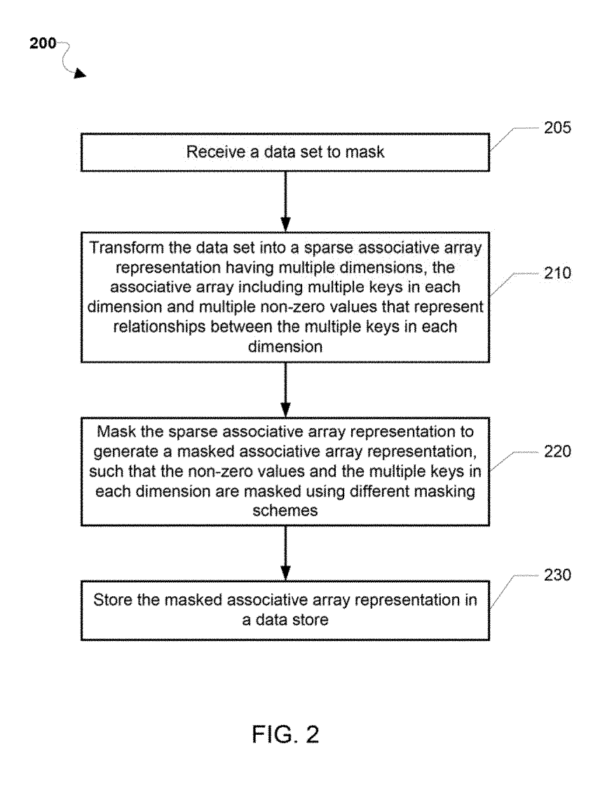

FIG. 2 is a process flow diagram illustrating a method of masking a data set based on a sparse associative array representation according to some embodiments. With reference to FIGS. 1 and 2, operations of the method 200 may be performed by a processor of a computing device (e.g., the processor 110 in the computing device 100).

In block 205, a processor (e.g., 110) may receive a data set to mask. In some embodiments, the data set may include one or more n-tuples, where each tuple is a sequence or ordered list of n elements. In some embodiments, the set of one or more n-tuples may be represented as a dense table of column keys and values. In some embodiments, the processor may receive a command that a reference (i.e., pointer) to the data set to be masked and an identifier for each of the different masking schemes to use in masking the data set

In block 210, the processor (e.g., 110) may transform the received data set into a sparse associative array representation having multiple dimensions. The sparse associative array representation may include multiple keys in each dimension and multiple non-zero values that represent relationships between the keys in each dimension. In some embodiments, the sparse associative array representation may represent complex key-value relationships in the form of a sparse matrix table or graph. For example, in some embodiments, a sparse matrix table may be generated from a dense table according to the Distributed Dimensional Data Model (“D4M”). According to the D4M model, the sparse matrix table may include a set of row keys, a set of column keys and a set of non-zero values that represent relationships (i.e., associations) between the row keys and column keys.

In some embodiments, each row key of the sparse matrix table may include a column key name selected from the dense table that is appended to a non-zero value of the selected column. Each column key of the sparse matrix table may include one of the remaining column key names of the dense table appended to a non-zero value of that column. Relationships between the row keys and column keys of the sparse matrix table may be identified by a non-zero value (e.g., 1) included in each cell that represents a related column-row pair. Further details on transforming a data set into a sparse associative array representation using the D4M schema are disclosed in U.S. Pat. No. 8,631,031, the entire contents of which are incorporated herein by reference.

In block 220, the processor (e.g., 110) may mask the sparse associative array representation to generate a masked associative array representation, such that the non-zero values and the keys in each dimension are masked using different masking schemes. For example, in some embodiments, the row keys, the column keys, and the values of a sparse matrix table (e.g., generated in block 210) may be masked using different masking schemes. In some embodiments, each of the row keys may be masked using a first masking scheme, each of the column keys may be masked using a second masking scheme, and each of the values of the sparse matrix table may be masked using a third masking scheme. In some embodiments, at least component of the associative array representation (e.g., row keys, column keys, or values) is masked using a different masking scheme than the masking scheme used to mask other components. In some embodiments, each of the different masking schemes applied to each component of the sparse associative array representation may be predetermined or manually selected.

In some embodiments, the masking scheme used to mask each component of the sparse associative array representation may depend on one or more of the desired functionality and/or operations to be performed on the masked associative array representation and the computational overhead that may be tolerated by a particular application or service. For example, in some embodiments, the different masking schemes may include semantically secure encryption (RND), deterministic encryption (DET), order-preserving encryption (OPE), digital authentication (AUT), additively homomorphic encryption (HOM+), and multi-party computation (MPC). Each of these different masking schemes may provide different levels of protection, enabling different types of operations to be performed on masked data. Further, each of these different masking scheme may be associated with respective computational overheads that may affect the processing time for performing certain operations. Thus, by representing a data set using a sparse associative array representation and separately masking each component of the representation using a set of different masking schemes, tradeoffs may be made between performance of desired operations on the masked data set and computational overhead.

Semantically secure encryption (RND) may encrypt each input data into different encrypted outputs (e.g., one plaintext to many ciphertexts). Thus, semantically secure encryption (RND) may leak negligible information about the input data from the encrypted data, and thus enabling the least functionality or number of operations to be performed on the encrypted data. For example, in some embodiments, semantically secure encryption (RND) may only enable decryption operations on the encrypted data by authorized users. In some embodiments, the relative computational overhead of RND encryption may range from 1 to 10 times greater than the computational overhead associated with unencrypted operations.

Deterministic encryption (DET) may encrypt each input data into exactly one encrypted output (e.g., one plaintext to one ciphertext). Thus, deterministic encryption (DET) may leak equality information about the input data from the encrypted data, thus enabling match functionality. For example, match or equality operations may be performed on a set of DET encrypted data given a DET encrypted query parameter. In some embodiments, the relative computational overhead of DET encryption may range from 1 to 10 times greater than the computational overhead associated with unencrypted operations.

Order-preserving encryption (OPE) may also encrypt each input data into exactly one encrypted output (e.g., similar to DET) and additionally preserves the relative order of the underlying data. Thus, order-preserving encryption (OPE) may leak equality and order information about the input data from the encrypted data, thus enabling range functionality. For example, match or equality operations may be performed on an ordered set of OPE encrypted data given a single or range of OPE encrypted query parameters. In some embodiments, the relative computational overhead of OPE encryption may range from 1 to 10 times greater than the computational overhead associated with unencrypted operations.

Multi-party computation (MPC) may be used to split a given function into multiple independent operations that may be executed on distinct processing elements to perform a number of mathematical operations such as addition, multiplication with as much leakage as RND encryption. In some embodiments, the relative computational overhead of MPC encryption may range from 1 to 3 orders of magnitude greater than the computational overhead associated with unencrypted operations.

Homomorphic additive encryption (HOM+) may encrypt each input data into a ciphertext that may be added to another HOM+ encrypted ciphertext. In some embodiments, HOM+ encryption may leak negligible about the input data from the encrypted data (e.g., similar to RND encryption). Digital authentication (AUT) may not use encryption to hide the data, but may append a hash of the data to protect data integrity.

In some embodiments, semantically secure encryption (RND) may be implemented using the OpenSSL Advanced Encryption Standard (AES) 256 block cipher in Cipher Block Chaining Mode or Galois Counter Mode. For example, a cryptographic key may be derived from a user-provided password and an 8-byte salt using 1000 rounds of a derived key generation loop. Each ciphertext may have a minimum length of one AES block and may be derived from both the cryptographic key and an initialization vector (IV) of 16 bytes. The IV may be generated using the OpenSSL command RAND_bytes, which generates an arbitrary length string of cryptographically strong pseudo-random bytes. Generation of a pseudo-random initialization vector (IV) may ensure that different ciphertext is generated each time the same plaintext is masked, thereby protecting equality information. To simplify string handling, ciphertexts may be converted into printable characters using Base64 encoding.

In some embodiments, deterministic encryption (DET) may be identical to semantically secure encryption (RND) except for the manner in which the initialization vector (IV) is generated for each unit of data to encrypt. For example, to leak only equality information, DET may require an initialization vector (IV) that is uniquely determined for each data unit. In some embodiments, the initialization vector may be uniquely determined for each data unit by truncating a Secure Hash Algorithm 1 (SHA-1) hash of the data unit to 16 bytes. In some embodiments, the OpenSSL SHA-256 implementation may be substituted for SHA-1 for more security, but results in an approximate 40% increase in computation time compared to using the SHA-1 hash.

In some embodiments, order-preserving encryption (OPE) may be implemented using a mutable order-preserving encryption (mOPE) model. For example, in some embodiments, the mOPE model may include a trusted client and an untrusted server that interact with each other. The untrusted server may not be given access to any plaintext values or user password, and the trusted client may not be required to store or analyze the entire data set at once. The masked data may be stored on the untrusted server in a binary search tree as ciphertexts. The ciphertexts may be obtained through deterministic encryption (DET) operations on the trusted client. Because ciphertexts do not leak order information, the untrusted server may communicate with the trusted client through an interactive session to determine the correct location in the binary search tree for each ciphertext. Starting at the root of the tree, the untrusted server may send the ciphertext of the current node to the trusted client. The trusted client decrypts the ciphertext at that node, compares the decrypted ciphertext to the plaintext being inserted, and returns a 0 (i.e., indicates left node) if the plaintext is less than the value at that node or a 1 (i.e., indicates right node) if the plaintext is greater. The new current node is then returned, and the process repeats. When the exact location of the plaintext to be inserted has been found, the trusted client sends the untrusted server the ciphertext of that value along with a command to insert it there in the tree. The OPE ordertext representation of a given plaintext may be the path to its ciphertext in the binary search tree, concatenated with padding of a 1 and a sufficient number of 0s to make all ordertexts the same size. In some embodiments, the default size of the ciphertext may be set to 16 bytes, thereby allowing for 216 entries if 0s and 1s are stored as strings or 2128 entries if the path is stored as bits. Querying for data (or a range of data) may occur by determining the position of the masked data.

Authentication (AUT) schemes may reveal all information of the data, but protects data integrity. For example, in some embodiments, although AUT may not encrypt the data at all, a hash-based message authentication code (HMAC) may be prepended to the plaintext. In some embodiments, the HMAC may be generated as a Secure Hash Algorithm 1 (SHA-1) hash of the message. In some embodiments, when an AUT-protected data is unmasked with AUT, the HMAC that is stored with the plaintext may be extracted and compared against a new HMAC calculated from the plaintext data and secret key. If the two are equal, the user may have confidence that the original plaintext data has not been modified since it was first stored as generating the same HMAC requires knowledge of the secret key. While AUT schemes do not ensure data confidentiality, AUT schemes may ensure data integrity.

In block 230, the processor (e.g., 110) may store the masked associative array representation in a data store. For example, in some embodiments, the data store may be a NoSQL database. NoSQL databases may be used in storage and retrieval of big data. In some embodiments, the NoSQL database may be implemented using an Apache Accumulo™ data store that supports sparse associative array representations according to the D4M data model. In some embodiments, the NoSQL database may be implemented using a Paradigm4 SciDB™ data store that also supports the D4M model.

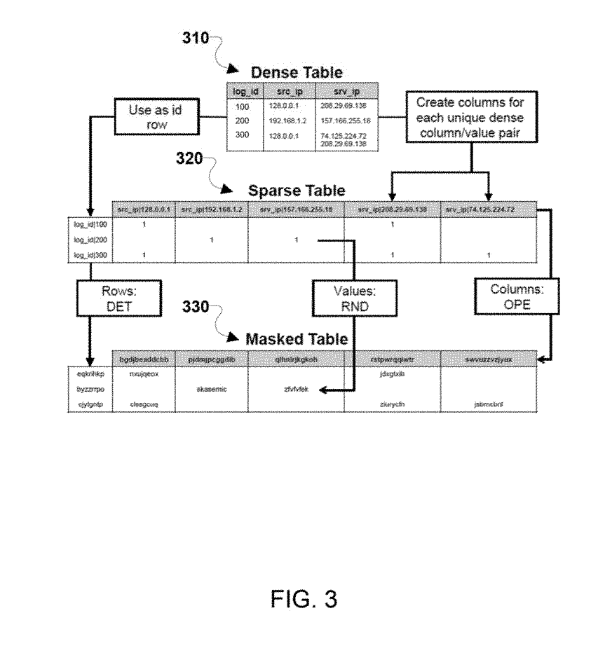

FIG. 3 is a schematic diagram illustrating an example of masking a data set based on a sparse associative array representation according to the method of FIG. 2. With reference to FIGS. 1-3, a processor of a computing device (e.g., processor 110) may receive a data set in the form of a dense table 310. In this example, the data set includes network traffic logs. As shown in FIG. 3, each log may be represented by 3-tuple that includes a log identifier, a source IP address, and a server IP address. Each value of a tuple may be associated with a respective column key identified in the dense table 310 as “log_id,” “src_ip,” and “srv_ip.”

In some embodiments, the dense table 310 may be transformed into a sparse associative array representation (e.g., a sparse matrix table 320) according to the Distributed Dimensional Data Model (“D4M”). As shown in FIG. 3, each row key of the sparse matrix table 320 may include a selected column key of the dense table 310 appended to a non-zero value of the selected column. In this example, the “log_id” column key and associated values are used as row keys, namely “log_id|100,” “log_id|200,” and “log_id|300.” Each column key of the sparse matrix table 320 may include one of the remaining column key of the dense table 310 appended to a non-zero value of that column. In this example, the column keys of the sparse matrix table 320 include “src_ip|128.0.0.1,” “src_ip|192.168.1.2,” “srv_ip|157.166.255.18,” “srv_ip|208.29.69.138,” and “srv_ip|74.125.224.72.” Relationships between the row keys and columns keys of the sparse matrix table 320 may be identified by inserting a non-zero value (e.g., 1) in each cell that represents a related column-row pair. By appending the column keys and values to make the sparse table columns and rows, most of the semantic content may be moved into the row keys and column keys of the sparse matrix table 320.

The row keys, column keys, and values of the sparse matrix table 320 may be masked using different encryption schemes to generate a masked matrix table 330. For example, as shown in FIG. 3, the row keys (i.e., log_id|001, log_id|002, etc.) may be masked using deterministic encryption (DET), the column keys (i.e., src_ip|128.0.0.1, src_ip|192.168.1.2, etc.) may be masked using order-preserving encryption (OPE), and the non-zero values may be masked using semantically secure encryption (RND). In some embodiments, equality operations may be performed directly on the masked row and column keys, which are encrypted using DET and OPE. Range operations may also be performed on the masked column keys, which are encrypted using OPE. In some embodiments, the non-zero values may be masked using an additively homomorphic encryption (HOM+) to enable performance of addition operations on the masked values of the table 330.

In some embodiments, DET and OPE encryption may induce random permutations on the rows and columns of the masked matrix table 330 as the rows and columns may be restricted in lexicographic order by their respective masks. However, the overall structure of the sparse table matrix 320 may be preserved in the masked matrix table 330. Linear algebra and the algebra of associative arrays, including sparse matrix tables, are typically invariant to such permutations (e.g. linear algebraic operations on the masked matrix table 330 may have the same effect as linear algebraic operations on the unmasked sparse matrix table 320). Thus, a wide range of algebraic operations may be performed on the masked data. In some embodiments, the masked matrix table 330 may be distributed to a remote computing device (e.g., 150 of FIG. 1) for storage and/or performance of various operations on the masked data.

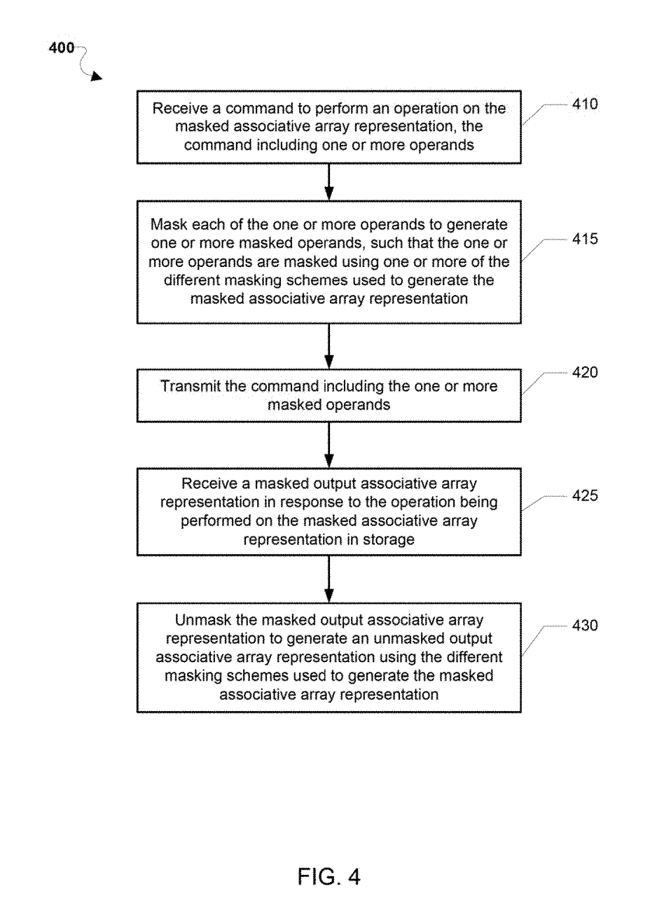

FIG. 4 is a process flow diagram illustrating a method 400 of performing an operation on a masked associative array according to some embodiments. With reference to FIGS. 1-4, operations of the method 400 may be performed by a processor of a computing device (e.g., the processor 110 in the computing device 100).

In block 410, the processor (e.g., 110) may receive a command to perform an operation on one or more masked associative arrays (e.g., the masked matrix table 330 of FIG. 3). In some embodiments, the operations that may be performed on the one or more masked associative arrays may include, but are not limited to, correlations, thresholds, search queries, and linear algebraic operations, such as addition, subtraction, multiplication, and Boolean operations. In some embodiments, the command may include one or more operands as inputs to the operation. For example, in some embodiments, the one or more operands may define a single plaintext string or value or a range of plaintext strings or values. In some embodiments, the command may also identify one or more of the different masking schemes for masking each of the one or more operands.

In block 415, the processor (e.g., 110) may mask each of the one or more operands to generate one or more masked operands. The one or more operands may be masked using one or more of the different masking schemes used to generate the masked associative array representation (e.g., in block 220 of FIG. 2). For example, in some embodiments, each operand may be masked using a different masking scheme identified in the command for that operand. In some embodiments, each operand may be masked using a different masking scheme depending on the order of the operands in the command. For example, the first operand may be masked using deterministic encryption (DET), the second operand may be masked using an order-preserving encryption (OPE), and the third operand may be masked using a semantically secure encryption (RND). In some embodiments, the order of the operands may correspond to an order of the components of the masked associative array representation (e.g., row keys, column keys, values) in which such plaintext strings or values are to be searched.

In block 420, the processor (e.g., 110) may transmit the command including the one or more masked operands. In some embodiments, the processor may transmit the command to a remote computing device (e.g., 150 of FIG. 1) to perform the requested operation directly on the masked associative array representation (e.g., the masked matrix table 330 of FIG. 3). In some embodiments, the remote computing device (e.g., 150) may include a data store, such as an Apache Accumulo™, a Paradigm4 SciDB™, or other NoSQL database.

In block 425, the processor (e.g., 110) may receive a masked output associative array representation in response to the operation performed on the masked associative array in storage (e.g., masked matrix table 330). In some embodiments, the masked output associative array representation may have a structure similar to the structure of the masked associative array representation in storage. For example, in some embodiments, the masked resultant associative array representation may have a structure similar to a masked matrix table (e.g., 330), including one or more row keys, one or more column keys, and one or more non-zero values that indicate relationships between the row keys and column keys. In some embodiments, the various components of the masked resultant associative array representation (e.g., row keys, column keys, and values) may be masked using the same masking scheme used to mask the components of the original masked associative array representation in storage (e.g., the masked matrix table 330).

In block 430, the processor (e.g., 110) may unmask the masked output associative array to generate an unmasked output associative array representation using the different masking schemes used to generate the masked associative array representation in storage. For example, if the masked matrix table in storage (e.g., 330) is masked using deterministic encryption (DET) to encrypt the row keys, order-preserving encryption (OPE) to encrypt the column keys, and semantically secure encryption (RND) to encrypt the values of the array, DET, OPE, and RND may be used to respectively decrypt the row keys, column keys, and values of the masked output associative array in order to obtain the unmasked data (e.g., plaintext).

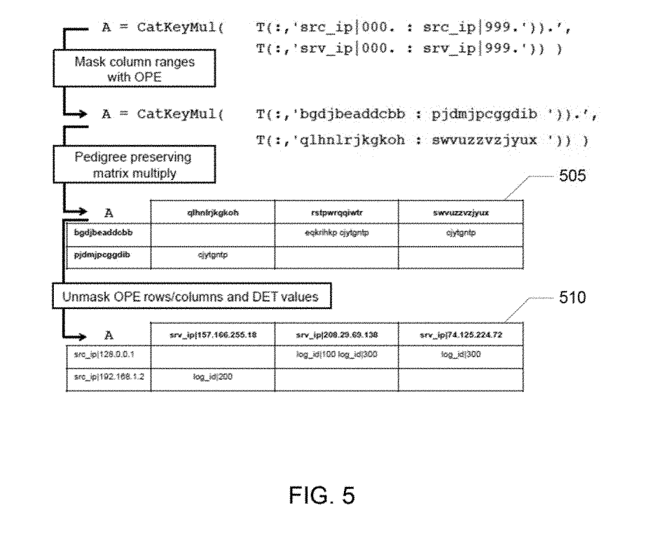

FIG. 5 is a schematic diagram illustrating of an example of performing an operation on a masked associative array according to the embodiment method of FIG. 4. With reference to FIGS. 1-5, a processor of a computing device (e.g., processor 110) may receive a “pedigree preserving” matrix multiply command (e.g., “CatKeyMul” command) In some embodiments, the CatKeyMul command may perform a matrix multiply on two associative arrays and output a resultant associative array including a set of values representing relationships between keys of the respective arrays (e.g., row and column keys). Exemplary source code for the CatKeyMul function may be available at https://github.com/Accla/d4m/blob/master/matlab_src/CatKeyMul.m. the entire contents of which are incorporated herein by reference.

For example, the CatKeyMul command may perform a pedigree preserving matrix multiply on two associative arrays derived from a single sparse table matrix (e.g., 320 of FIG. 3). As shown in FIG. 5, the first and second operands of the CatKeyMul command may identify selected column ranges corresponding to the respective associative arrays to be derived from the sparse table matrix (e.g., 320). For example, the first operand of the CatKeyMul command includes a plaintext string that identifies the first associative array as a transposed portion of the sparse table matrix (.e.g., 320) including a range of “src_ip” keys. The second operand of the CalKeyMul command includes a plaintext string that identifies the second associative array as a portion of the sparse table matrix (e.g., 320) including a range of “srv_ip” keys. Because the sparse table matrix (e.g., 320) may be stored in encrypted form as a masked matrix table (e.g., 330), the plaintext strings serving as the first and second operands of the CatKeyMul command may be masked using the same masking scheme(s) used to mask the column keys and the row keys of the masked matrix table in storage (e.g., 330). For example, in this example, both operands are masked using order-preserving encryption (OPE). In some embodiments, the command may be modified to explicitly identify the masking scheme to apply to each operand.

In response to execution of the CalKeyMul command (e.g., by a remote computing device 150), the command may return with a masked result. In this example, the masked result 505 is a masked resultant associative array representation 505 where the column and row keys are masked using order-preserving encryption (OPE) and the values are masked using deterministic encryption (DET). The masked result 505 may be unmasked to obtain the unmasked result of the pedigree preserving matrix multiply by using the same respective masking schemes to decrypt the masked row keys, column keys and values. In this example, the unmasked result is an associative array representation 510 of a “src_ip” to “srv_ip” matrix table with corresponding lists of log_id's stored in the values. As illustrated by this example, the query parameters of the command (i.e., operands) and the results of the command operations may be masked and unmasked independently from the storage and computation systems.

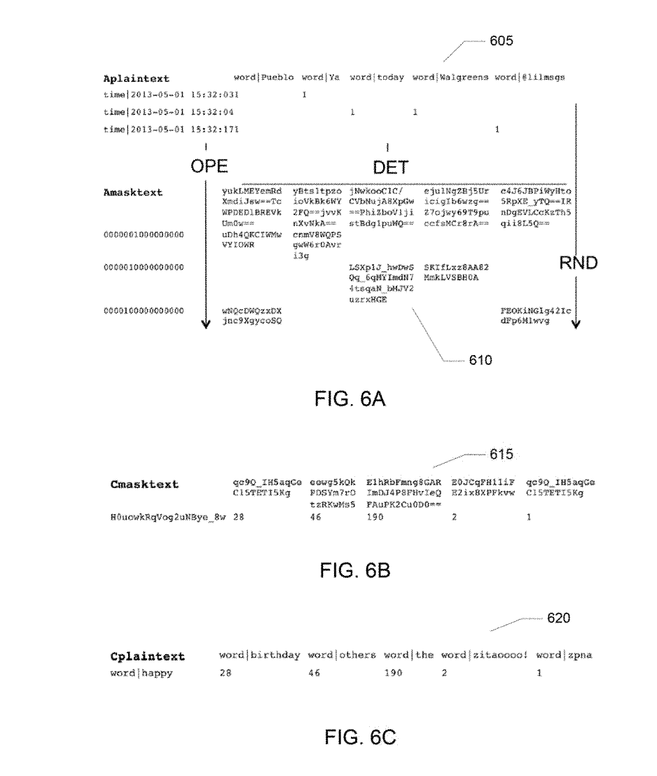

FIGS. 6A through 6C are schematic diagrams illustrating of another example of performing an operation on a masked associative array representation according to the embodiment method of FIG. 4. With reference to FIGS. 1-6C, a processor of a computing device (e.g., processor 110) may perform a correlation operation which determines the most common words that exist within a sample set of messages as a term of interest (t1). In this example, the set of messages are Tweets™ collected from the social media website Twitter™ and the term of interest is “happy.”

FIG. 6A is a schematic diagram that illustrates a masked associative array representation (e.g., Amasktext 610) generated from a sparse associate array representation (e.g., Aplaintext 605) containing word strings in the collected Tweet™ messages. As shown, the sparse associate array representation 605 may include a set of column keys that include specific words found in the Tweets (e.g., Pueblo, Ya, today, etc.) and a set of row keys that may include a timestamp for each Tweet. A non-zero value (i.e., 1) links each word to one or more of the time stamped Tweets. The masked associative array representation 610 may be generated from the sparse associate array representation 605 by masking the column keys with deterministic encryption (DET), the row keys with order-preserving encryption (OPE) and the values with semantically secure encryption (RND).

In some embodiments, the processor (e.g., 110) may receive a correlation command that includes the term of interest (e.g., t1=“happy”) as an masked operand. The masked term of interest may be correlated against the masked associative array representation 610 of the data set (e.g., Tweets) by performing a matrix multiply between a transpose of the masked term of interest (“happy”) and the masked associative array representation 610 (e.g., Amasktext). For example, in some embodiments, the correlation command may be expressed as Cmasktext=Amasktext (:, Mask(t1))′*Amasktext.

FIG. 6B is a schematic diagram that illustrates a masked output associative array representation 615 (i.e., Cmasktext) resulting from the correlation operation. In some embodiments, the processor (e.g., 110) may receive the masked output associative array representation in response to the correlation operation being performed by a remote computing device (e.g., 150) on the masked associative array representation (e.g., 610) in storage. In response to receiving the masked output associative array representation 615 (e.g., Cmasktext), the processor may unmask the masked output by decrypting the various components of the masked output associative array representation (e.g., column keys, row keys, values) using the same masking schemes used to mask the original data set. For example, in some embodiments, the unmask command may be expressed as Cplaintext=Unmask(Cmasktext, OPE, DET, RND), where the first operand specifies the masked associative array representation to unmask and the remaining operands identify the masking scheme to use in decrypting the various components of the masked associative array representation.

FIG. 6C is a schematic diagram that illustrates an unmasked output associative array representation (i.e., Cplaintext 620) resulting from an unmasking operation. As shown in FIG. 6C, the unmasked output associative array representation 620 includes a set of column keys of all words that exist within a sample set of Tweet™ messages as the term of interest in the row key (e.g., “word|happy”). The values of the unmasked output associative array representation 620 indicates the number of times the word of each column key was found with the term of interest.

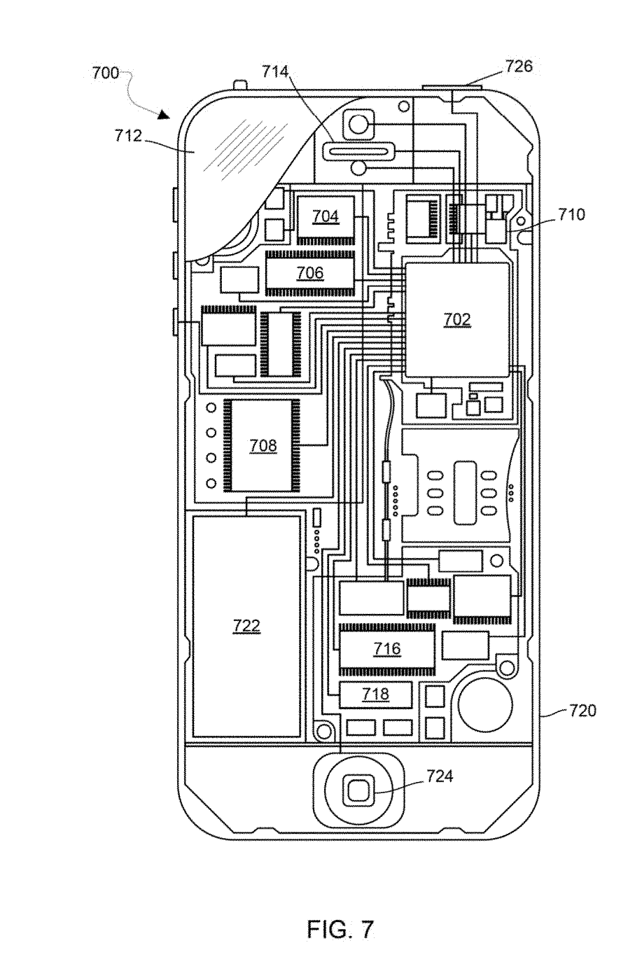

The various embodiments may be implemented on any of a variety of commercially available computing devices. For example, FIG. 7 is a schematic diagram illustrating components of a smartphone type mobile communication device 700 that may be configured to implement methods according to some embodiments, including the embodiments of the methods 200 and 400 described with reference to FIGS. 2 and 4. A mobile communication device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the communication device 700 need not have touch screen capability. Additionally, the mobile communication device 700 may include a cellular network transceiver 708 coupled to the processor 702 and to an antenna 704 for sending and receiving electromagnetic radiation that may be connected to a wireless data link. The transceiver 708 and the antenna 710 may be used with the above-mentioned circuitry to implement various embodiment methods.

The mobile communication device 700 may have a cellular network transceiver 708 coupled to the processor 702 and to an antenna 710 and configured for sending and receiving cellular communications. The mobile communication device 700 may include one or more SIM cards 716, 718 coupled to the transceiver 708 and/or the processor 702 and may be configured as described above.

The mobile communication device 700 may also include speakers 714 for providing audio outputs. The mobile communication device 700 may also include a housing 720, constructed of a plastic, metal, or a combination of materials, for containing all or some of the components discussed herein. The mobile communication device 700 may include a power source 722 coupled to the processor 702, such as a disposable or rechargeable battery. The rechargeable battery may also be coupled to the peripheral device connection port to receive a charging current from a source external to the communication device 700. The communication device 700 may also include a physical button 724 for receiving user inputs. The mobile communication device 700 may also include a power button 726 for turning the mobile communication device 700 on and off.

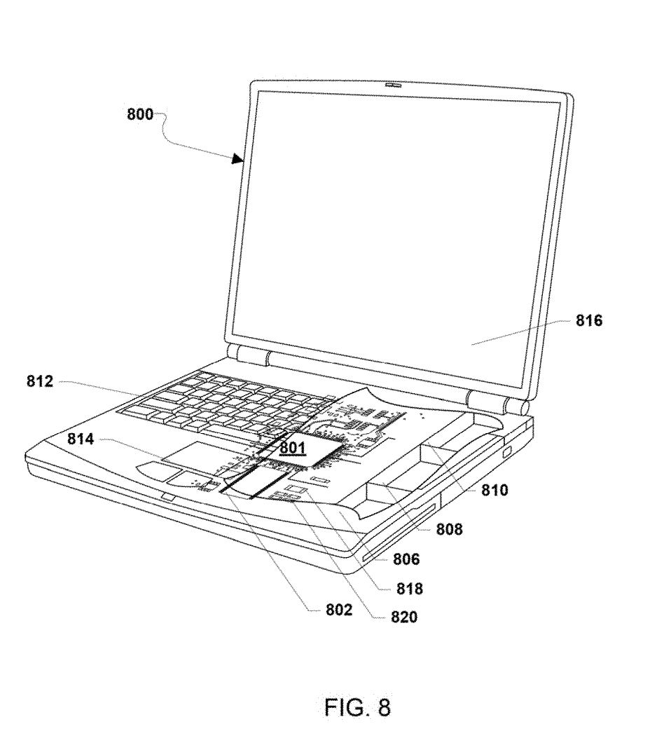

Other forms of computing devices, including personal computers and laptop computers, may be used to implementing the various embodiments. For example, FIG. 8 is a schematic diagram illustrating components of a laptop computing device 800 that may be configured to implement methods according to some embodiments, including the embodiments of the methods 200 and 400 described with reference to FIGS. 2 and 4. In some embodiments, the laptop computing device 800 may include a touch pad 814 that serves as the computer's pointing device, and thus may receive drag, scroll, and flick gestures similar to those implemented on mobile computing devices equipped with a touch screen display and described above. Such a laptop computing device 800 generally includes a processor 801 coupled to volatile internal memory 802 and a large capacity nonvolatile memory, such as a disk drive 806. The laptop computing device 800 may also include a compact disc (CD) and/or DVD drive 808 coupled to the processor 801. The laptop computing device 800 may also include a number of connector ports 810 coupled to the processor 801 for establishing data connections or receiving external memory devices, such as a network connection circuit for coupling the processor 801 to a network. The laptop computing device 800 may have one or more radio signal transceivers 818 (e.g., Peanut®, Bluetooth®, ZigBee®, Wi-Fi®, RF radio) and antennas 820 for sending and receiving wireless signals as described herein. The transceivers 818 and antennas 820 may be used with the above-mentioned circuitry to implement the various wireless transmission protocol stacks/interfaces. In a laptop or notebook configuration, the computer housing includes the touch pad 814, the keyboard 812, and the display 816 all coupled to the processor 801. Other configurations of the computing device may include a computer mouse or trackball coupled to the processor (e.g., via a USB input) as are well known, which may also be used in conjunction with the various embodiments.

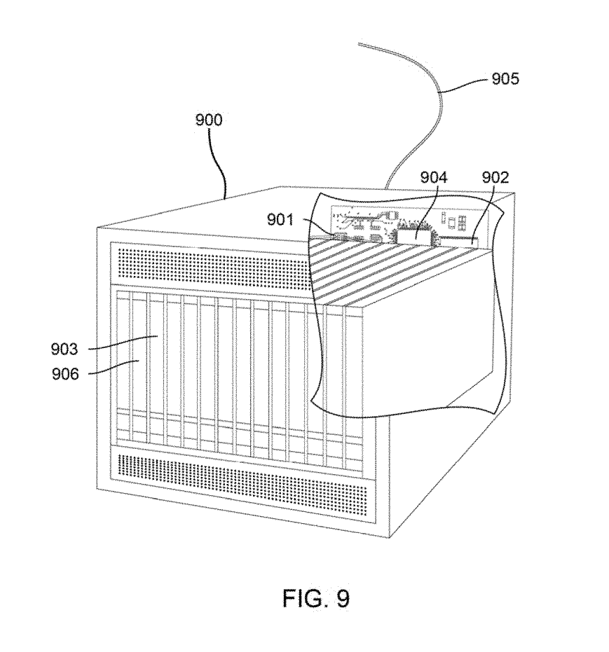

FIG. 9 is a schematic diagram illustrating components of a server 900 that may be configured to implement methods according to some embodiments, including the embodiments of the methods 200 and 400 described with reference to FIGS. 2 and 4. Such a server 900 typically includes a processor 901 coupled to volatile memory 902 and a large capacity nonvolatile memory, such as a disk drive 903. The server 900 may also include a floppy disc drive, compact disc (CD) or DVD disc drive 906 coupled to the processor 901. The server 900 may also include network access ports 904 coupled to the processor 901 for establishing data connections with a network 905, such as a local area network coupled to other broadcast system computers and servers.

The processor 901 may be any programmable microprocessor, microcomputer or multiple processor chip or chips that can be configured by software instructions (applications) to perform a variety of functions, including the functions of the various embodiments described above. In some embodiments, multiple processors may be provided, such as one processor dedicated to wireless communication functions and one processor dedicated to running other applications. Typically, software applications may be stored in the internal memory 902, 903 before they are accessed and loaded into the processor 901. The processor 901 may include internal memory sufficient to store the application software instructions.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a two or more microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of masking a data set and performing computations on the masked data set, comprising:
transforming, by a processor, the data set into a sparse associative array representation having a plurality of dimensions, wherein the sparse associative array representation comprises a plurality of keys in each of the plurality of dimensions and a plurality of non-zero values that represent relationships between the plurality of keys in each of the plurality of dimensions; and
masking, by the processor, the sparse associative array representation to generate a masked associative array representation, wherein the plurality of non-zero values and the plurality of keys in each dimension are masked using a plurality of different masking schemes; and
storing, by the processor, the masked associative array representation in a data store.

2. The method of claim 1, wherein the plurality of different masking schemes comprise semantically secure encryption (RND), deterministic encryption (DET), order-preserving encryption (OPE), authenticated encryption (AUT), additively homomorphic encryption (HOM+), multi-party computation (MPC), or any combination thereof.

3. The method of claim 1, wherein each of the plurality of keys in each of the plurality of dimensions of the sparse associative array representation comprises a key name and a value.

4. The method of claim 1, further comprising:
receiving, by the processor, a command to mask the data set, wherein the command comprises the data set and an identifier for each of the plurality of different masking schemes to mask the plurality of non-zero values and the plurality of keys in each dimension of the sparse associative array representation.

5. The method of claim 1, wherein the plurality of keys in each of the plurality of dimensions of the sparse associative array representation comprise a plurality of column keys and a plurality of row keys, wherein the plurality of non-zero values represent relationships between the plurality of column keys and the plurality of row keys and wherein masking the sparse associative array representation to generate the masked associative array representation comprises:
masking, by the processor, the plurality of non-zero values, the plurality of column keys and the plurality of row keys using the plurality of different masking schemes.

6. The method of claim 1, further comprising:
receiving, by the processor, a command to perform an operation on the masked associative array representation, wherein the command comprises one or more operands;
masking, by the processor, each of the one or more operands to generate one or more masked operands, wherein the one or more operands are masked using one or more of the plurality of different masking schemes used to generate the masked associative array representation; and
transmitting, by the processor, the command including the one or more masked operands.

7. The method of claim 6, wherein the operation to perform on the masked associative array representation comprises one or more of a correlation, threshold, search query, addition, subtraction, multiplication, or Boolean operation.

8. The method of claim 6, further comprising:
receiving, by the processor, a masked output associative array representation in response to the operation being performed on the masked associative array representation; and
unmasking, by the processor, the masked output associative array representation to generate an unmasked output associative array representation using the plurality of different masking schemes that were used to generate the masked associative array representation.

9. The method of claim 1, wherein each of the sparse associative array representation and the masked associative array representation is a sparse table matrix.

10. A computing device, comprising:
a processor configured with processor-executable instructions to:
transform a data set into a sparse associative array representation having a plurality of dimensions, wherein the sparse associative array representation comprises a plurality of keys in each of the plurality of dimensions and a plurality of non-zero values that represent relationships between the plurality of keys in each of the plurality of dimensions; and
mask the sparse associative array representation to generate a masked associative array representation, wherein the plurality of non-zero values and the plurality of keys in each dimension are masked using a plurality of different masking schemes; and
store the masked associative array representation in a data store.

11. The computing device of claim 10, wherein the plurality of keys in each of the plurality of dimensions of the sparse associative array representation comprise a plurality of column keys and a plurality of row keys, wherein the plurality of non-zero values represent relationships between the plurality of column keys and the plurality of row keys and wherein to generate the masked associative array representation the processor is configured with processor-executable instructions to:
mask the plurality of non-zero values, the plurality of column keys and the plurality of row keys using the plurality of different masking schemes.

12. The computing device of claim 10, wherein the processor is configured with further processor-executable instructions to:
receive a command to perform an operation on the masked associative array representation, wherein the command comprises one or more operands;
mask each of the one or more operands to generate one or more masked operands, wherein the one or more operands are masked using one or more of the plurality of different masking schemes used to generate the masked associative array representation; and
transmit the command including the one or more masked operands.

13. The computing device of claim 12, wherein the processor is configured with further processor-executable instructions to:
receive a masked output associative array representation in response to the operation being performed on the masked associative array representation; and
unmask the masked output associative array representation to generate an unmasked output associative array representation using the plurality of different masking schemes that were used to generate the masked associative array representation.

14. The computing device of claim 10, wherein each of the sparse associative array representation and the masked associative array representation is a sparse table matrix.

15. A non-transitory processor-readable storage medium having stored thereon processor-executable instructions configured to cause a processor of a computing device to perform operations comprising:
transforming a data set into a sparse associative array representation having a plurality of dimensions, wherein the sparse associative array representation comprises a plurality of keys in each of the plurality of dimensions and a plurality of non-zero values that represent relationships between the plurality of keys in each of the plurality of dimensions; and
masking the sparse associative array representation to generate a masked associative array representation, wherein the plurality of non-zero values and the plurality of keys in each dimension are masked using a plurality of different masking schemes; and
storing the masked associative array representation in a data store.

16. The non-transitory processor-readable storage medium of claim 15, wherein the plurality of keys in each of the plurality of dimensions of the sparse associative array representation comprise a plurality of column keys and a plurality of row keys, wherein the plurality of non-zero values represent relationships between the plurality of column keys and the plurality of row keys and wherein to generate the masked associative array representation the stored processor executable instructions are configured to cause the processor to perform operations comprising:
masking the plurality of non-zero values, the plurality of column keys and the plurality of row keys using the plurality of different masking schemes.

17. The non-transitory processor-readable storage medium of claim 15, wherein the stored processor executable instructions are configured to cause the processor to perform operations further comprising:
receiving a command to perform an operation on the masked associative array representation, wherein the command comprises one or more operands;
masking each of the one or more operands to generate one or more masked operands, wherein the one or more operands are masked using one or more of the plurality of different masking schemes used to generate the masked associative array representation; and
transmitting the command including the one or more masked operands.

18. The non-transitory processor-readable storage medium of claim 17, wherein the stored processor executable instructions are configured to cause the processor to perform operations further comprising:
receiving a masked output associative array representation in response to the operation being performed on the masked associative array representation; and
unmasking the masked output associative array representation to generate an unmasked output associative array representation using the plurality of different masking schemes that were used to generate the masked associative array representation.

19. The non-transitory processor-readable storage medium of claim 15, wherein each of the sparse associative array representation and the masked associative array representation is a sparse table matrix.

20. A computing device, comprising:
means for transforming a data set into a sparse associative array representation having a plurality of dimensions, wherein the sparse associative array representation comprises a plurality of keys in each of the plurality of dimensions and a plurality of non-zero values that represent relationships between the plurality of keys in each of the plurality of dimensions; and
masking the sparse associative array representation to generate a masked associative array representation, wherein the plurality of non-zero values and the plurality of keys in each dimension are masked using a plurality of different masking schemes; and
storing the masked associative array representation in a data store.
